(19) United States
(12) Patent Application Publication
(10) Pub. No.: US 2009/0019163 A1
(43) Pub. Date: Jan. 15, 2009

(54) Network management system & method

(76) Inventor: Vivian Pecus, Springfield, VA (US)

Correspondence Address: HARNESS, DICKEY & PIERCE, P.L.C., P.O. BOX 8910, RESTON, VA, 20195, US

(21) Appl. No.: 12/213,684

(22) Filed: Jun. 23, 2008

Related U.S. Application Data
(62) Division of application No. 10/950,587, filed on Sep. 28, 2004.

(51) Int. Cl. G06F 15/173

(52) U.S. Cl. 709/226; 709/223

(57) ABSTRACT

A network management method includes receiving network requirements of a network application/service of an entity. Thereafter, network resource capability is determined over a plurality of network providers to meet the received network requirements. Finally, network resources of at least one of the plurality of network providers are dynamically assigned to the network application/service, upon determining network capability over the plurality of network providers, to meet the received network requirements.

### FIELD OF THE INVENTION

The present invention is generally directed to the field of network management, and more preferably managing operation of a network such as communication networks for routing communications over a network, such as the internet for example.

### BACKGROUND

Many new network services and applications have recently been emerging in the networking world. Such applications may include, for example, streaming audio and video, voice (including but not limited to voiceover IP {VoiP}, a form of QoS based service and application), e-commerce, out-sourced corporate applications, etc. are included in such applications. Such services can include, but are not limited to search, security layers underlying applications such as VPN for example, etc. These applications and services, and others like them, need an end to end service that is provisioned correctly.

Provisioning of a network service or application requires that specific conditions, unique to each service or application, be met by any network(s) carrying the service or application to ensure correct execution of these service or applications. These conditions may include, but are not limited to, specific amounts of bandwidth, amounts of latency that can possibly be endured, aspects of jitter which could be endured, etc. as well as other requirements based on the particular network or particular service or application.

Currently, technology such as “a synchronous transfer mode” (ATM) networks offer items such as bandwidth differentiated services. However, these ATM networks and other technologies used for provisioning service or applications on networks involve pre-reserving network bandwidth. This may result in congestion, an inefficient use, a waste of network bandwidth, etc. Further difficulties can result when a plurality of different network providers are used. When multiple network providers are used to support a network service or application, for example, network inefficiencies are often amplified and other problems often result.

Technical innovations from Quality of Service (QoS) forms have established standards and parameters for network services or applications. In addition, the technology vendors who developed and manufactured network devices (including routers, switches, servers, etc.), applications, and network management systems are incorporating these standards or QoS parameters. Similar Class of Service (CoS) parameters have also been developed for network services. However, both QoS and CoS parameters have been underutilized thus far due to, for example, lack of widespread adoption of common parameters by multiple service providers.

The Internet Engineering Task Force has established RFC2748 “The Common Open Policy Service” (COPS) standard for the interaction of various provisioning approaches. Further, proposed standards from these bodies have now created two approaches: COPS-PR (Provisioned approach) and COPS-Outsourced (Outsourced approach). Fundamentally, the two approaches are functioned in the following ways.

Before discussing the approaches, some terminology should be defined. First, in a managed network, there are boundaries. At these boundary points, decisions are made regarding the allowing or refusing of traffic information flow into or out of the network, for example. A Policy Enforcement Point (PEP) is the point where the decision is enforced (i.e. a router, a firewall blocking the traffic, etc.). A PDP (Policy Decision Point) is at the network information base and acts like an access control list, to make the decision as to whether or not to allow the traffic, for example.

In the Provisioned approach, the QoS is pre-reserved and the service is satisfied when the network resource is requested. In the Outsourced approach, a Policy Enforcement Point (PEP) queries a PDP (Policy Decision Point) to request the network resource when needed, if the network resource is approved by the PDP. However, these existing provisioning approaches still suffer from inefficiencies, especially resulting from pre-reservation of network resources and from situations where network resources of multiple networks are needed/desired.

Currently, the dynamic nature of QoS/CoS, if not pre-reserved, are limited by the capacity of the router to buffer (DiffServ), for example. If it is over-provisioned (i.e. too many simultaneous requests), the routers will drop bits. Thus, the end to end contract is not guaranteed.

Currently, standards work and engineering efforts of the network manufacturers are not working hard to develop technological components required to inter-operate across different networks. This is because different networks, offered by different network providers, have their own capabilities and requirements. Thus, the only way to operate over several different network providers is to pre-reserve time on the network through each separate provider and to provide network requirements in advance. Again, the aforementioned inefficiencies result. Hence the pre-reserving of certain requirements such as bandwidth and endurable latency for example, has to an inefficient use of the network capability.

### SUMMARY OF THE INVENTION

The inventors of the present application have recognized these and other problems regarding the existing provisioning of network resources. They have further recognized the amplification of these problems, as well as other problems (such as billing and usage tracking for example), when multiple network providers are used.

For example, in one embodiment, the inventors have recognized that the current state of the art mainly has two types of PEP/PDPs of a committed information rate (guaranteed) or best effort (i.e. festival seating). They have recognized that there has been no attempt to manage capacity in between. In addition, across network providers, they have recognized that there is no coordination among multiple providers (in an airline analogy, in one embodiment, the inventors have developed the equivalent of code sharing, wherein an end user does not necessarily know who operates every leg of the flight from origin to destination, for example leaving United from Washington to Munich you can fly United to London, then fly on a Lufthansa plane to get to Munich.

Further, in one embodiment, the start of the session, once started, may be guaranteed until the session is completed. However, not every session need be guaranteed. For example, like a phone call on a busy network, once started you keep the line, but if the switch is overloaded at the start your call is not made.

The inventors of the present application have further recognized that there is a need for third party global directory or registry services to enable operation across multiple network providers and to capture and enhance the benefits of QoS and CoS platforms. The inventors of the present application have recognized that such global directory or registry services can provide unique registration for applications, policies, resources of network providers, etc. The inventors of the present application have also recognized that the ability for a particular network application or service to signal or indicate particular network resource requirements to network exists, as well as the ability of the networks and network providers to understand and provide those resource requirements; and that these existing tools need to be harnessed and adequately utilized in a network management method or system. The network management and registry methods and systems of various embodiments of the present invention recognize and fulfill these needs.

The inventors of the present application have further recognized that the ability to provide services via Operational Support Systems (OSSs) and policy powered networks also exist, and that these services are currently limited to the scope of an Autonomous Systems (AS) or private network/domains. The inventors of the present application have recognized that current limitations breakdown at the “peering points” in the network and that at these locations, service providers currently make available bands of bandwidth attached to a particular class of service that tracks usage by bandwidth alone. Thus, despite the adoption of ATM technology for many years, the ability to dynamically use the QoS provisions of this technology has been unrealized. The inventors of the present application have finally recognized that the main problem is the inability to dynamically allocate bandwidth and resources across separate carriers, and have solved at least one of these and/or other problems in a number of different ways as will be explained hereafter.

Thus, it is an object to the present application, in one embodiment, to provide a network management method which receives network requirements of a network application or service; determines network resource capability over a plurality of network providers to meet the receive network requirements; and dynamically assigns network resources of at least one of the network providers to the network application or service to meet the receive network requirements. As such, network resources such as routers, switches, servers, etc. can be utilized efficiently and network requirements such as bandwidth, endurable latency, endurable jitter, etc. of network applications, and/or other provisioning requirements, can be met.

In addition, by such dynamic assigning and tracking of network providers, usage can be tracked and billing more easily and readily allocated. These applications can be applications of service providers, application developers, consumers, application providers, etc. and can enable applications such as streaming online video, voiceover IP, etc., as well as services, to be provisioned correctly and to operate correctly over a network, such as the internet for example, using one or more of a plurality of network providers.

Additionally, in an embodiment of the present application, a network application registry method can be developed wherein requirements of network applications or services are registered or stored in a registry; network capabilities of a plurality of network providers are also registered or stored in a registry; and network requirements of applications on the network can then be dynamically coordinated based upon the registered information, wherein the dynamic coordination can be between a plurality of network providers. These requirement of network applications can be registered for service providers, application developers, consumers, application providers, etc., and the network applications can include streaming audio, streaming video, voiceover IP, etc. The network requirements can include QoS requirements of the network application, Class of Service (CoS) requirements of a network application, etc. As such, the QoS/CoS provisioning can be used to dynamically coordinate network requirements of applications or services between a plurality of network providers on a network. Further, such a registry system can be used to track usage on each of the various networks for accounting and billing purposes for example.

Another embodiment of the present application is directed to a method for registering network resource requirements of an application or service on a network for plurality of users and suppliers (in a database registry for example), and generating a globally unique ID for each registered user and supplier. As such, information relating to the registered network resource requirements and generated globally unique IDs can be exported to a network management system for dynamic coordination of network resources for a service or application on a network, or over a plurality of networks. Using this generated globally unique ID for the user and supplier, network usage can be tracked, for accounting and/or billing purposes, for example.

Such a globally unique ID can be generated, registered and then used as a type of label. For example, it may, but need not, be appended to an IP data packet, for example, to identify a user, application provider, network provider, etc. as the sender of the packet. As such, network usage can be tracked and allocated to a user/provider/etc., even over network resources of a plurality of network providers. In addition, an end to end session label may be created. Further, network use of a network provider can also be tracked. This information can be used for usage/accounting/billing purposes.

In one embodiment, the network service registry method can be used for registering service providers and for registering network services and/or associated supportable applications for each service provider. Thereafter, a globally unique ID can be generated for each registered network service and/or provider, Class of Service (CoS) requirements can be registered for each network service and supportable application, and the CoS requirements for each network service and supportable application can be dynamically coordinated across a plurality of networks.

In another embodiment, a network resource registry method can be for network providers, wherein network providers are registered and network resources for a network provider are also registered. Thereafter, a globally unique ID can be generated for each registered network resource and provider, network capabilities of each network resource can be registered, and network resource information can be exported to a micromanagement system for dynamic coordination of network resources of a plurality of networks for applications on the network.

In yet another embodiment, a consumer registry for network users can include registering consumer organizations, registering network users for each consumer organizations, generating a globally unique ID for each registered consumer organization and network user, and registering service and application privileges for each network user. It may further include generating user templates for registering a new user with privileges similar to those of a previously registered user.

Still further, in another embodiment, a validation method can be created for at least one of the network session, connection or transaction. This can include receiving a request from a registered network resource for access to a registered application originally requested by a registered network user, sending the receive request to a registered network resource with access to the requested service application, and reviewing the request against registered network management policies to determine if at least one of a session, connection and transaction is valid and if sufficient resources are available. Thereafter, a response to the registered network user can be sent back to the registered network resource, and resources can be dynamically allocated and at least one of the session validated, a connection initiated, and a transaction validated, if the requested is approved.

In another embodiment, an accounting data collection method for a registered session can include generating usage indicators for consumers, applications and services on the network, and generating usage indicators for resources on the network. Thereafter, usage information can be exported to a third party system for at least one of analysis, accounting, and billing purposes for one or more aspects involved, including but not limited to network usage, networks involved, etc.

These and other objects and aspects of the invention will become more readily apparent from an understanding of the exemplary embodiments described below.

### BRIEF DESCRIPTION OF THE DRAWINGS

The present invention will become more fully understood from the detailed description of the exemplary embodiments given here and below in the accompanying drawings, which were given by way of illustration only and thus are not limited with the present application, and wherein:

FIG. 1 illustrates the network management system of an embodiment of the present application and connection through a network to various other entities;

FIG. 2 illustrates the network management system of an embodiment of the present application and connection to a network;

FIG. 3 illustrates further details of the registry of the network management system of an embodiment of the present application;

FIGS. 4A-4E illustrate an example of a validation method in connection with an embodiment of the present application;

FIG. 5 illustrates a validation method of an embodiment of the present application; and

FIG. 6 illustrates an accounting data collection system of an embodiment of the present application.

### DETAILED DESCRIPTION OF THE EXEMPLARY EMBODIMENTS

An embodiment of the present application is directed to a network management method in which network requirements (including but not limited to jitter or latency tolerations of an application/service, bandwidth allocation requirements of an application/service, etc.) of a network application and/or service are received. From these received requirements, network resource capability over a plurality of network providers is determined in an effort to meet these network requirements. Finally, network resources of at least one of the plurality of network providers are dynamically assigned to the network application or service, upon determining network capability over the plurality of network providers to meet the received network requirements.

As such, network applications and/or services provided by application developers or application providers, such as streaming audio and video, voiceover IP, e-commerce, out-sourced corporate applications, etc. can be correctly provisioned based upon their network requirements. Further, resources of network providers, such as routers, switches, servers, etc., can be adequately allocated to ensure both proper provisioning of the network application and improved use of allocatable bandwidth of the network providers.

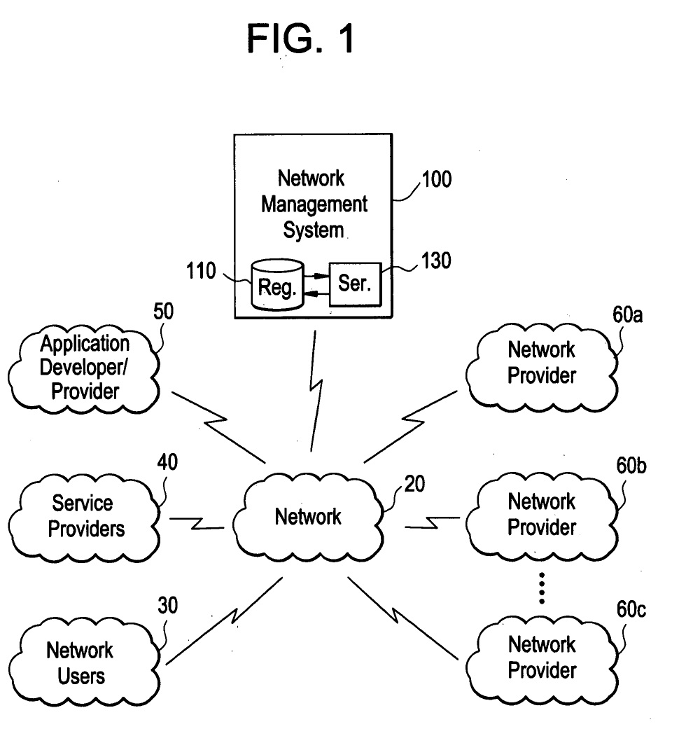

A general illustration of a network management system 100 of an embodiment of the present application is shown in FIG. 1. Such a system includes a type of registry or database 110, as well as a server 120, noting that the entire network management system 100 can exist solely on the server 120, or that the server 120 can accommodate the registry 110. The network management system 100 is connected to a network 20, such as the internet for example. In addition, a plurality of network providers 60a, 60b, 60c, etc., providing the infrastructure such as routers, switches, servers, etc. for the network 20, are also connected to the network 20.

In addition to the network providers 60a-60c, who provide network resources for the network 20, users 30 of the network 20 can also connect to the network 20. Typical network users 30 can include consumers for example. In addition, service providers 40 can also be connected to the network 20, for providing services to network users 30. In addition, application developers and/or application providers 50 can also be connected to the network 20. These application developers and/or providers 50 can provide network applications such as streaming audio and video, etc. to a network user 30 or others over the network 20, upon the network providers 60a-60c properly allocating their network resources. Through the network management system 100 and the registry 110, such network resource allocation can be properly achieved.

Previously, network applications lacked the capabilities to inform networks 20 and network providers 60a-60c of their particular provisioning requirements, such as bandwidth requirements for example. Now, network applications which are “Quality of Service (QoS) aware” (and services which are “Class of Service (CoS)” aware) are reaching the market. These network applications are dependent on the ability of the network 20 to become aware of their provisioning needs (such physical requirements as bandwidth latency, amount of bandwidth, ability to be throttled up or down, etc.).

In order for the network application to traverse the network 20, the network 20 must be capable of understanding the network requirements of the network application and determine if the network, supplied by the various network providers 60a-60c, can meet the requirements. Then, resources of the network providers 60a-60c must be assigned to the particular network application. The provisioning of resources of the network 20, provided by the network providers 60a-c, must be transparent to the network application from the context of serving network users 30 across multiple network providers 60a-c. By dynamically assigning network resources of at least one of a plurality of network providers to the network application, upon determining network capability over the plurality of network providers, network requirements of a particular network application can be met by the network management system 100 of an embodiment of the present application.

Accordingly, a network management method has been created which can, in one embodiment, maintain a registry 110 of network application and/or network resource requirements, services and availability. Further, network resources of a plurality of network providers, and/or network resource capabilities can also be maintained in the registry 110. In addition, other information such as network users and their connection privileges and/or standardized network management policies can also be maintained in such a registry 110. By the use of such a registry 110, in conjunction with QoS and/or CoS parameters of network applications and/or services, network resources of at least one of a plurality of network providers 60a-60c can be dynamically assigned to the network application or service. As network capabilities of the plurality of network providers 60a-c are registered, and as network requirements of a particular network application or service can be determined, the network management system 100 of an embodiment of the present application can achieve such dynamic assignment or provisioning of network resources of at least one of a plurality of network providers 60a-60c to a network application or service. The determination can be made, for example, using registered parameters and taking a dynamic view of existing resources, to ensure that the requested network application or service is properly provisioned.

Upon receiving network requirements of a network application or service, when an end user initiates or attempts to use the network via an application or service, and determining or receiving resource capability of a plurality of network providers 60a-c, network resources of at least one of the plurality of network providers 60a-c can be dynamically assigned to the network application upon determining network capability over the plurality of network providers 60a-c to meet the received network requirements. As such, allocation of network resources can be dynamically managed based on network application resource requirements and network resource availability. Further, access to the network management system 100 can be provided for multiple subscribing application developers, service providers, network providers, consumers or network users, system administrators, etc. As such, validation, coordination, and enablement of data service connections for multiple consumers or network users across multiple networks (which may be autonomous policy-based) and systems of various network providers 60a-c can be dynamically achieved.

More specifically, the network management system 100, including the registry 110, may act to encapsulate multiple types of information into public key/private key combinations to permit adequate and efficient resource allocation and usage charges. This encapsulated information can include, but is not limited to at least one of received network application/service requirements (potentially including QoS and/or CoS parameters for example), application and/or service provider information, network provider information potentially including information relating to allocatable resources, etc.

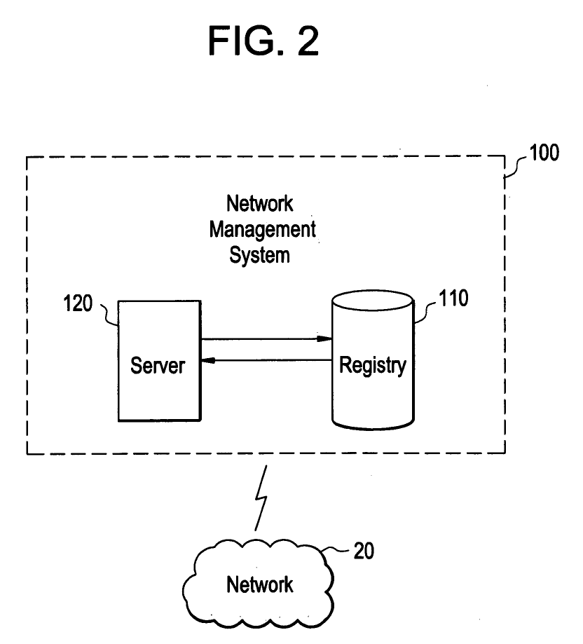

FIG. 2 illustrates a network management system 100 of an embodiment of the present application, including the server 120 and the registry 110. Connection to the network 20 is shown, wherein it is understood that further connection, through network 20, can also exist with various network providers, network users, service providers, application developers, and application providers, etc.

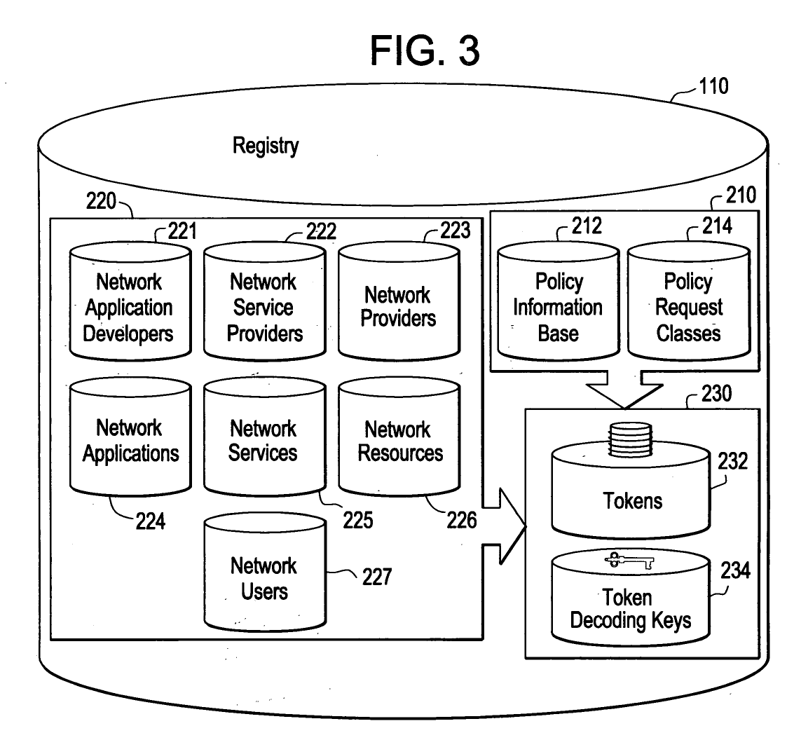

As stated previously, the network management method of the present application, in one embodiment, has the ability to track network application users and services across networks of a plurality of network providers. In one embodiment, this is done utilizing a type of registry, wherein network requirements of a network application are received and network resource capability over a plurality of network provider may also be received. Thereafter, it can be determined which of the plurality of network providers have network resource capability to meet the receive network requirements. An example of such a registry 110 shown in FIG. 3 of the present application.

The registry 110 can include, in one exemplary embodiment, three (3) separate “sets” of information. One set of information 210 can include policy information base (PIB) or database or data store, as shown by element 212, and policy request classes as shown by element 214 of FIG. 3. The service and/or network providers thus agree/not agree to handle certain types of services/applications and gain agree on how to charge for them based on the tracked information. The application developers/service providers can further register their policies. In addition, network providers, etc. can also register the services regarding their equipment (software used in conjunction with servers, routers, switches, etc.), as well as their software policies. As such, policy decisions, regarding applications/services and network resources can be properly made. These can include, but are not limited to yes/no, offered at a premium, etc. depending on business arrangements.

A second set of information in the registry 110 can include that stored as element 220, including network requirements of applications of network application developers 221; network requirements of services of network service providers 222; network resource capabilities of network providers 223; network requirements of network applications 224; network requirements of network services 225; information/requirements regarding network resources 226 of each of the plurality of network providers; and/or information regarding network users 227 including capability and provider abilities for example. Thus, the registry can be for any or all of the aforementioned categories of users and/or providers.

Finally, in a third section of registry 110, indicated as element 230 in FIG. 3, tokens 232 and token decoding keys 234 can be stored. These tokens 232 can correspond to usage indicators for users, application or service providers, network providers, etc. Such tokens 232 can be used as an indicator of a type of usage information for accounting and billing purposes for example. The tokens 232 can thus provide access to services based on privileges and network resource availability, and decoding keys can further be used to provide billing information to electronic clearing houses for accounting and billing purposes for various ones of the users, service providers, application providers and developers, and/or network providers.

For example, the tokens 232 may have embedded therein, all needed atomic information including, but not limited to time of use, networks used, destination, special rate plans, etc. These tokens 232 can then be used by billing systems to generate appropriate bills.

More specifically, the information stored in registry 110 can include information such as, for example, bandwidth agents that permit exchange of network resource bandwidth based on service level agreements, for example. The Network management system 100, including the registry 110, can use the registered information to coordinate network resource traffic for different service and/or application providers to provide clearing house capability for multiple service providers, application developers, consumers, application providers, etc. to utilize network resources of a plurality of network providers in a shared manner. This can be done, for example, because the providers are using similar sets of transactions, protocols, etc. to exchange information and to permit the exchange of information. At certain policy enforcement points (PEP) of the network, traffic can be permitted to pass, for example, and then reports of this passing traffic can be accounted for and passed on to the network provider for usage/accounting purposes. This can be done, for example, during the set up or session initiation time for the creation of tokens 232.

In addition, application and/or service level maps can be developed. As service and/or application providers submit new information, as new network nodes are developed, as new network resources are provided, etc., new bandwidth can be provisioned for an application and/or service and new maps can be developed. These maps can include network coverage information for multiple providers. As providers see coverage for other providers, they can aggregate service maps, etc.

Thus, multiple types of information (regarding a network application, application provider, network provider, QoS parameters, etc.) can be encapsulated into a public key/private key combination to allow for appropriate usage/accounting purposes. Such a public key/private key combination can be something like a Certificate Authority (CA) operation. The provider registers with the CA, and then the consumer buys from the provider with a trust protection of the transaction's integrity based upon the CA third party assurance. For example, the registry 110 may allow application developers to register requirements of their application, such as bandwidth needs for example. The registration can include minimum requirements of the network application; can define nominal requirements for the network application; and/or can enable Application Service Providers (ASPs) to meet their Service Level Agreements (SLAs). Further, as will be explained later, a globally unique ID can be generated for a network application and/or service to track usage of a particular application and/or service and to therefore permit collection of usage information for accounting and/or billing purposes.

Stored application information can be exported to other network management systems (NMS) such as, for example: HP-open view, Tivoli, Spectrum, and other OSS/NMS software for example. This information can allow the development of agents that allow for the execution of rules. The rules can be those, for example, that govern who can access the information, what they are permitted to do, how to track the exchange, etc. From there, a set of tokens can be provided for reconciliation at a clearing house, for example, for billing, usage, and/or accounting purposes as will be described in a later embodiment of the present application. This can further allow for the development of template (multi-carrier policies) profiles for network providers. Such template profiles can include, for example, a template profile for video conferencing done by one carrier/provider that provides video conferencing, to allow other network providers/carriers to offer the same compatible service. One current example is the ability of users of different ISPs to instant message (IM) between themselves.

Such a registry system 100 can further interface with servers, routers, switches and other network devices of network providers (at PEPs, for example); and can support multiple roles of registrations including application developers, application service providers, application users, network service providers, clearing house providers, network map providers, content providers, internet service providers, etc.

In such a registry 110 as shown in FIG. 3, various types information may be registered for various entities. This information can include, but is not limited to, the following:
Application developers registration can be for, but is not limited to, high quality service consumption applications and their network resource requirements for example (e.g. Microsoft can register their Interactive Meeting application). Such a registration can include, but is not limited to, identification and contact information including, for example, corporate identification (name, EIN, D&B information, address, etc.); application identification information (such as title, version, expiration date, OS dependencies, etc.; protocol (HTTP, TCP, RTSP, etc.); quality of service and/or resource requirements (jitter tolerances, bandwidth, latency tolerances, degradation capability, QoS requirements, etc.). This registered information may further be used to generate a globally unique ID for the application developer.
Application service providers can register data services, for example (e.g. Earthlink may register their mobile data services or Charter Communications may register their integrated video services). The registration can include, but is not limited to, as part of the ASP registration for example, corporate identification and other contact information, application supported, network provider used, etc. Further, data service information can include, but is not limited to, identification information, resource availability (e.g jitter tolerances, bandwidth, latency tolerances, degradation capability, QoS requirements, etc.). In response to this information, a globally unique ID for the application service provider may be generated.
For the user, the user may register identification and contact information, application and/or service privileges. This information can include, but is not limited to, corporate identification, locations, service provider used, etc. In response to this information, a globally unique ID may be generated for the application user. Further, a customer organization may register identification and contact information, and may register users and/or their application and/or service privileges (e.g. Bb's Widgets may register their management level employees).
For the network providers, contact and identification information may be registered as part of the registration process. A network provider can register network resources and capabilities (e.g. Sprint may register their IP network resources and capabilities). This can include, but is not limited to, corporate information, application supported, bandwidth provided, policy supported, etc. This can further include, but is not limited to, identification information for resources such as devices with smart peering capabilities, multiple protocol label switching (MPLS) labels, edge systems (e.g. routers, multimedia gateways, etc.), and technical capabilities such as specific protocol supported, specific domains supported, etc. In response to this information, a globally unique ID may be generated.
With regard to clearing house (CH) providers, various information may be registered as part of the CH registration. Credit card processors use this kind of information for credit card transactions on the Internet. This can include, but is not limited to, corporate information, billing approach, policy supported, etc.
With regard to network map providers, information may be registered as part of the network map provider registration period. This can include, but is not limited to, corporate information, application supported, peering points and coverage, etc.
With regard to content providers, information may be registered as part of the content provider registration, such as Microsoft live conferencing, for example, which is a combination of application and the service to provide the bandwidth. This can include, but is not limited to, corporate, application, QoS requested, registration restrictions, etc.
Regarding internet service providers, information may be registered as part of the ISP registration. This is another carrier type that should provide types of bandwidth services that they support. This can include, but is not limited to, corporate information, policy supported, end user supported, etc.
Further, the network management system may register identification information and its network management policies (e.g. standard class policies, policy information base, central policy information, standard report formats, etc.).

Thus, for example, an application developer may register bandwidth needs. This can include, but is not limited to,

registering minimum bandwidth requirements of a network application;

defining normal requirements for an application (jitter tolerances, latency tolerances, degradation capability, etc.); and

enabling the ASP to meet a service level agreement (SLA), wherein a globally unique ID can be generated from this information.

The registered information is thus stored or otherwise exported into the network management system 100. Such registered information allows for, for example, the development of agents that execute rules and provide sets of tokens for reconciliation at a clearing house, for example. The system 100 is thus able to track and mange relationships between applications, services, network resources for a plurality of networks, users and network management policies.

It further can allow for the development of templates (multi-carrier policies)/profiles for network bandwidth providers. It also can permit the selling of bundled templates to enterprises. Built in standard (policy request class, PRC) templates can provide network management rules for session validation, for example. In turn, the network bandwidth providers can discount enterprise customers using a standard template. Routers, switches, servers and other network devices can additionally be interfaced (PEPs). The registered information can further permit the “auto-provisioning” of network systems, as well as support automated service level agreements. Such auto-provisioning can be thought of as being analogous to voice conferencing wherein, once one subscribes to the service, one can set up a conference call anytime it is needed and one need merely provide end users with a number, pass code, and time of the call. The call then occurs, and at the end, bills are sent out to the subscriber.

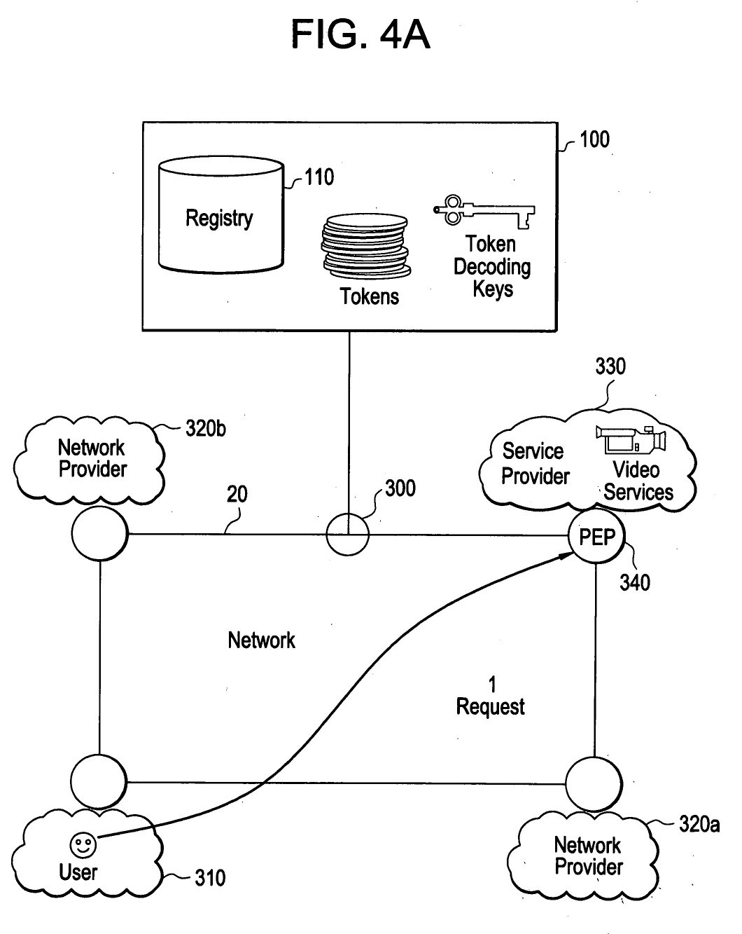

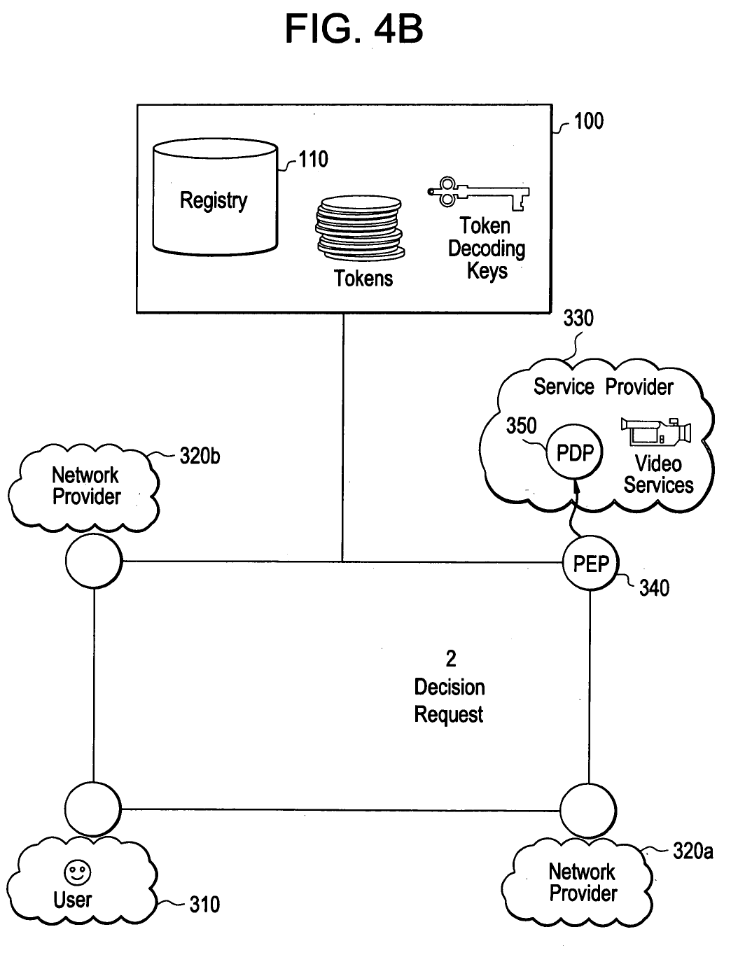

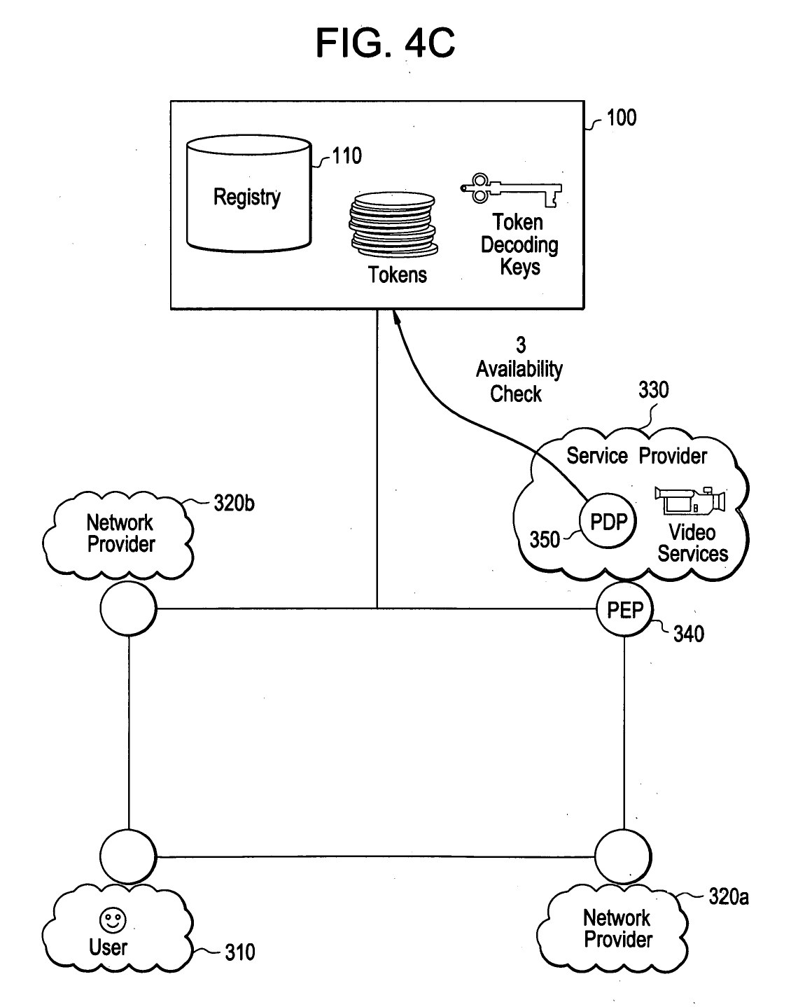

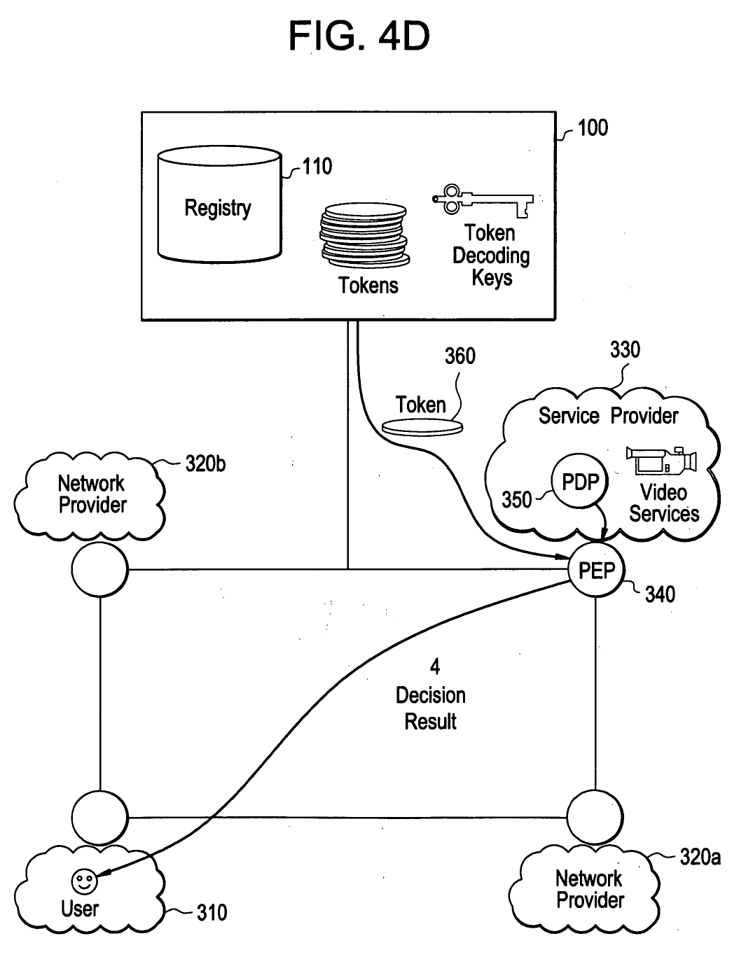

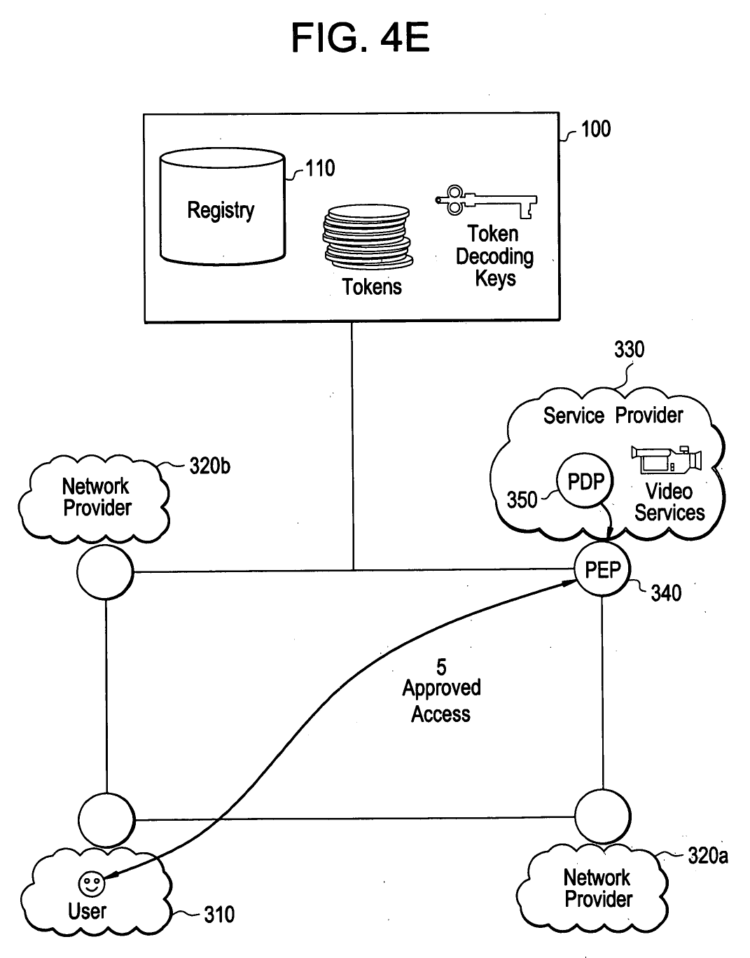

One exemplary embodiment of a network management method of the present application is shown with regard to FIGS. 4a-4e. In such an embodiment, a validation method for at least one of a network session, connection and transaction is described.

As shown in FIG. 4a for example, the network management 100 is illustrated, including the registry 110. The registry 110 is connected to the network 20 through various signal transfer points 300. These signal transfer points also connect the network 20 to the user 310, network providers 320a and 320b, and to a service provider 330.

In the first step of the methodology, a request from a network resource is received from a provider, regarding access of the network by a registered network application. In other words, a request is made to use a portion of the network, provided by a registered network provider. This request can be made on behalf of registered network user 310 desiring to use the registered network application. The registered application may be offered by a registered service or network application provider 330, and a determination is made at a policy enforcement point or PEP 340.

Next, moving to FIG. 4b, the received request is sent to a registered network resource at a policy decision point or PDP 350, requesting access to the requested service or application. Thus, the request for use of the network service or application requires information from both registered service or network provider and the network provider regarding the network resource. As both entities are registered with the system 100 in the registry 110, proper provisioning of network resources can be determined and achieved to allow the user 310 to receive the network application or service from the provider 330.

Accordingly, as shown in FIG. 4c, the request is reviewed against registered network management policies and registered information to determine if at least one of a network service/application session, connection and transaction is valid and if sufficient network resources are available. Note that a session begins with a connection and there is at least one transaction per session. As such, at PDP 350, the request is reviewed by the system 100 against registered network information to determine if the request is valid and if network resources, among a plurality of network providers, are available. This is done in connection with the information stored in the registry of network management system 100.

Thereafter, as shown in FIG. 4d, a response is sent to the registered network user, back through the network resources. At this time, a session token may be generated. The system 100 can provide this session token to the registered service or network provider, and the registered network resource can send access of the decision to the registered network user. The system 100 may just store the token to indicate usage, or my send it to a clearing house, for example.

Finally, as shown in FIG. 4e, if network access is approved, network resources can be allocated and at least one of a sessions is validated, a connection is initiated and a transaction is validated. If access is approved, the registered network resource can grant its resources and initiate a user session. Further, usage of the application/service, by the user, and using the network resources of one or more network providers can all be tracked. As such, usage tokens can be generated and can then be sent to a clearing house, for example, for usage tracking and/or billing and/or accounting purposes. Further, management system 100 allocates the proper resources and therefore also sends information to the network providers regarding resource allocation such that the service provider and user can utilize the service through the network devices offered by the network providers 320A and 320B.

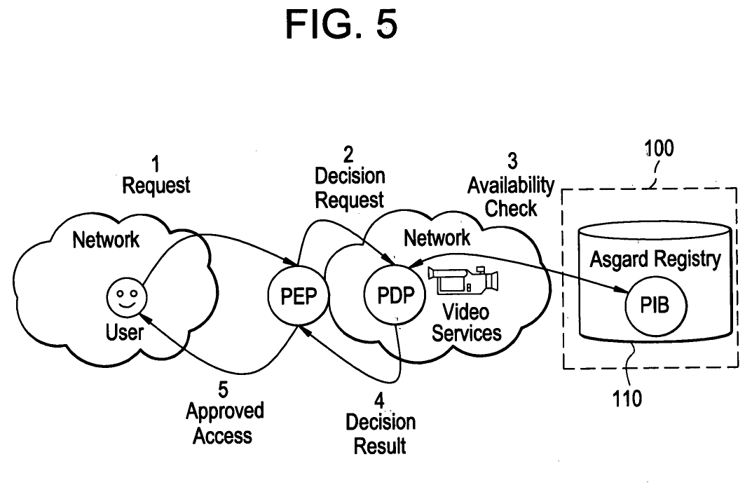

FIG. 5 illustrates a summary of the validation method of FIGS. 4a-4e, noting that the validation can be for any of a network session, network connection, and network transaction. A network session or transaction may be validated, and such a network connection can be initiated, for example.

FIG. 5 illustrates the various steps of receiving a request to access a registered application from a registered network user, formulating a decision request, checking on network resource availability from a plurality of network providers, forwarding a result of the decision request, and approving access. The method may use, for example, a policy-based network resource management approach. Thus, the registered network user requests access to a registered application and this request is received or identified by the system 100 as a request from a registered network at the PEP 340, for access to a registered application; the system 100 then sends a request to a registered network resource (i.e. PDP or policy decision point) with access to the requested service and application; the system 100 reviews the request against registered network management information and/or policies (i.e. stored in the PIB or policy information base) to determine if a connection, transaction or session is valid and if sufficient network resources of any of the plurality of network providers are available. Thereafter, the system 100 then sends a response back through the registered network PEP, to the registered user (the initiating network requester); and if the request approved, the system dynamically allocates network resources and initiates a connection if necessary. Subsequently, the user may then terminate the connection. The system 100 is thus able to use service differentiation for each connection/session/transaction to look ahead and enable network resource requirements for an application to be met by at least one of a plurality of network providers, and then dynamically pre-provisions the request.

Thus, a validation methodology for at least one of a network session, connection, and transaction, can be created. Such a methodology can include receiving a request from a registered network resource for access to at least one of a registered service and application, originally requested by a registered network user and sending the received request to a registered network resource with access to the requested at least one of service and application. Thereafter, the request may be reviewed against registered network management policies to determine if at least one of a session, connection and transaction is valid and if sufficient resources are available. Next, a response may be sent to registered network user back through the registered network resource. Finally, if the request is approved, resources may be dynamically allocated and at least one of a session may be validated, a connection may be initiated, and a transaction may be validated. In addition, the methodology may further include generating reconcilable tokens for reconciling at least one of: application existence within a service on the network; network user privileges for application within a service on the network; network requirements of the application on the network; network resource availability for application on the network; and network user session/connection/transaction approval codes.

Further, reconcilable tokens can be generated for reconciling purposes, such as for usage, accounting and/or billing purposes. A unique token can, for example, be generated for each session, connection, transaction (noting that a connection or session could generate multiple transactions) according to which participants and resources are involved (user/network provider/application provider/etc.). Such reconcilable tokens can be generated for reconciling at least one of application existence within a service on the network; network user privileges for an application within a service on the network; network requirements of the application on the network; network resource availability for an application on the network and network user session/connection, transaction approval codes. The system 100 may collect session statistics for usage/accounting/billing/etc. purposes, and may maintain, and/or send to one or more clearing houses, that can be provided to service/network providers as input to their billing activities. Standard reconciliation report formats may be used to provide detailed accounting information for service providers.

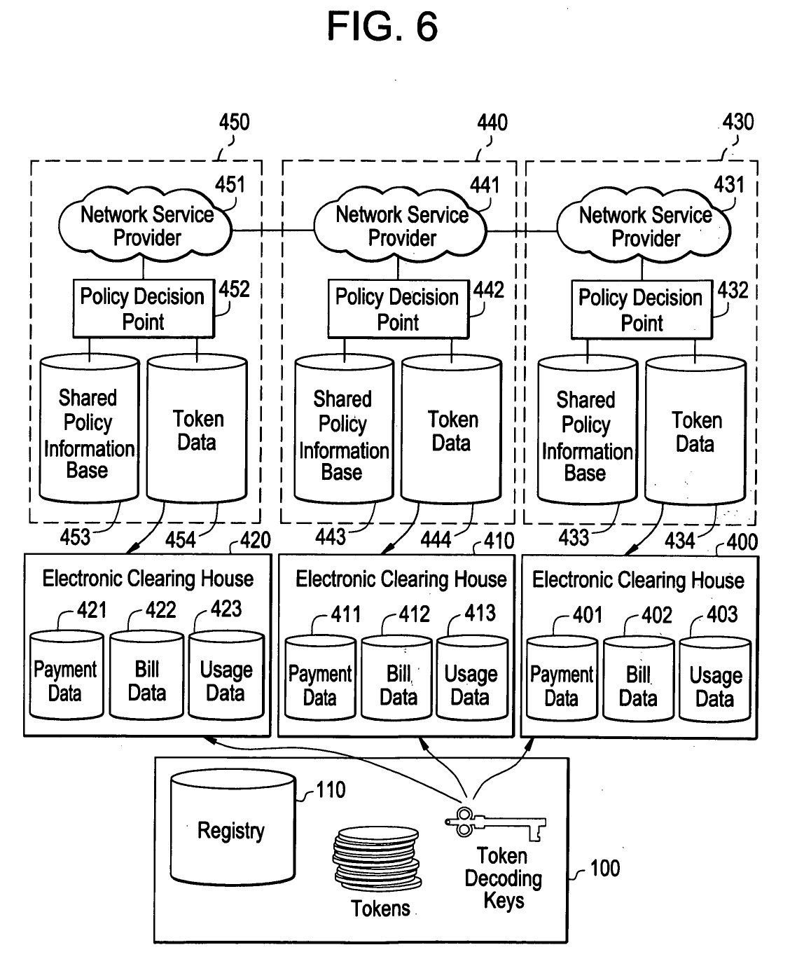

An accounting data collection method of another embodiment of the present application will be described with regard to FIG. 6 as follows.

FIG. 6 illustrates an accounting data collection system of the present application including the network management system 100 and the registry 110. This embodiment illustrates the use of electronic clearing houses.

In this embodiment, the network management system 100 can connect, through any type of network such as the internet for example, to one or more electronic clearing houses 400, 410 and 420. Each of these clearing houses, which may be represented by a single clearing house for example, then further connects to information systems 430, 440 and 450 for each of the network service provider 431, 441, and 451 for example. Accordingly, although the embodiment is not limited as such, a separate clearing house can be set up for each network service provider.

Each electronic clearing house 400, 410, 420 can include, for example, databases for storing payment data (401, 411 and 421); billing data (402, 412 and 422); and usage data (403, 413 and 423). Each of the boxes 430, 440 and 450 references a network service provider (431, 441, 451); policy decision point (432, 442 and 452); and databases for accumulating token data (434, 444, 454) and shared policy information data (433, 443 and 453). Note that a policy decision point (432, 442 and 452) is a term representing network intelligence that determines whether or not to allow a network application or service request to receive the network resources requested.

Thus, in such a system, an accounting data collection method can generate usage indicators for consumers or other users of a network. Further, usage indicators can be generated for applications on the network; usage indicators can be generated for services on the network; and usage indicators can be generated for resources of the network, including resources of a plurality of network service providers. Thus, these network resources are configurable options for handling information, wherein depending on the configuration used, network indicators and/or tokens can track network usage. Accordingly, as each network service provider 431, 441, 451 utilizes its resources, token data can be generated and stored in the token databases 434, 444 and 454, and can then be sent to the clearing houses 400, 410, 420. The registry 110 of the network management system 100 can further track usage of consumers, network applications, network services, etc. and can send this information to the clearing houses 400, 410 and 420.

Based upon this received information, the clearing houses 400, 410 and 420 can then, as a type of third party system, utilize this information for analysis, accounting and billing purposes. For example, usage data for a particular user can be calculated based upon this information, and bills can be generated for the network usage of the user. Similarly, information can be tracked for applications or services on the network, which can be paid either by a user or by an application or service provider, to a network service provider for example. Of course, a portion of these fees can further go to the network management system 100 for tracking this information and network usage.

As such, by exporting this usage information to a third party system for at least one of analysis, accounting and billing purposes, information regarding network usage can be adequately tracked. Thus, an accounting data collection methodology for a registered session may be developed. Such a methodology may include generating usage indicators for consumers on a network; generating usage indicators for applications on the network; generating usage indicators for services on the network; generating usage indicators for resources of the network; and exporting information regarding the generated usage indicators to a third party system for at least one of analysis, accounting, and billing purposes. Therefore, not only can network services and applications be adequately provisioned on the network, and not only can network resources of various network service providers, providing resources to the network, be adequately allocated, but usage of the network and of the network resources can be adequately tracked such that the usage information can be used for analysis, accounting or billing purposes.

In a corporate service level agreement (SLA) scenario for example, application developers may register their applications; ASPs may register which applications and QoS/CoS parameters they will support, generating policies (stored in the policy information base); network service providers may register and agree to provision their networks with the ASPs policy request classes or PIBs; and/or application users may register and activate the network for usage. As such, the NSPs, ASPs and application users will have usage tokens sent to the appropriate clearing house 400, 410 or 420 for usage/billing/accounting purposes. This can occur, for example, in a manner similar to a credit card transaction where an NSP and/or ASP sends transactions for processing so they can reconcile what is owed.

In a CP scenario, content providers can register their high value critical pages that they need (i.e. their ordering pages, like web pages for example, where they want to ensure that these have a higher response rate so that consumers do not abandon transactions), and appropriate QoS/CoS parameters; NSPs can create provisioning policy supporting the request; and the end users can access the service. Thereafter, tokens may be generated and sent to the appropriate clearing houses 400, 410, 420 for usage, billing, and accounting purposes.

As such, an improved network management method and system are created. It should be noted that the methodology described in each of the various embodiments can be performed by a system, wherein the system may include some type of computer device (including a processor) and a memory (which can be some type of database for example). The methodology of any of the various embodiments can exist as a network management method for receiving network requirements of an application; determining network resource capability over a plurality of network providers to meet the received network requirements; and dynamically assigning network resources upon determining network capability to meet the received network requirements. The network requirements of any of the various embodiments can include, but are not limited to at least one of jitter and/or latency tolerances, bandwidth allocation, etc. and can be obtained, for example, from requirement parameters associated with network application such as quality of service (QoS) or class of service (CoS) requirements of the network application. The network applications can be for any of a plurality of entities including, but are not limited to, at least one of service providers, application developers, consumers and application providers.

The methodology can further include maintaining a registry of network applications and corresponding network resource requirements for a plurality of network providers. Access to the registry can be permitted for at least one of subscribing application developers, service providers, network providers, consumers, network users and system administrators for any of the various purposes previously discussed. Further, the dynamic assigning of network resources of any of the various embodiments can include, but is not limited to dynamically validating, coordinating, enabling, etc. network resource connections across a plurality of network providers. The network(s) may include autonomous policy-based networks and systems of a plurality of different network providers.

The methodology of any of the aforementioned embodiments can further include collecting and even storing information regarding the dynamic assignment of network resources for at least one of accounting and billing purposes, wherein information regarding the dynamic assignment/allocation of network resources for each network application received may be stored. Further, the embodiments described in the various figures may be used in combination with one another.

As described above, an embodiment of the present application further embodies a network application registry method including registering requirements of network applications; registering network capabilities of a plurality of network providers; and dynamically coordinating network requirements of applications on the network based upon the registered information, wherein the dynamic coordination includes dynamic coordination between a plurality of network providers. A system employing such a method thus need only include a component for registering both requirements of applications and network capabilities of a plurality of network providers; and a component for dynamically coordinating network requirements of applications on the network based upon the registered information.

The methodology of any of the aforementioned embodiments can further include network application requirements including, but not limited to bandwidth allocation, latency and/or jitter tolerance, etc. At least one of the requirements and capabilities may be registered for at least one of service providers, application developers, consumers, application providers, etc. The network applications may further include, but are not limited to at least one of streaming video, streaming audio, voiceover IP, e-commerce, etc. In addition, application service level maps may be developed from registered requirements of the providers of the network applications in any of the aforementioned embodiments.

Further, the dynamic coordination/allocation/assigning of network resources in any of the aforementioned embodiments may include, but is not limited to the use of bandwidth agents, permitting exchange of bandwidth based on service level agreements, for example. The network requirements can include, but are not limited to QoS requirements and/or CoS requirements of the network application or service. Network capabilities in any of the embodiments may include, but are not limited to, at least one of smart peering, multiple protocol label switching (MPLS) labels, end systems, support for specific protocols, and support for specific domains. For example, the MPLS labels may be registered (mapped to a session requirements), wherein the MPLS labels assigned to a type of network traffic, can be used to shape and route network traffic over a plurality of network providers.

Further, rules for adaptive allocation of network resources, based upon the exported information, may be generated. In addition, a globally unique IDs may be generated for a registered application; wherein network applications can further include requirements needed to permit normal functionality of the network application such as minimum jitter and minimum latency, for example. Generating an ID is something done in the software development field routinely for other purposes, such as in the assignment of class objects in the object oriented field, for example. However, by maintaining a registry, and by having multiple providers consult with the same registry, a truly globally unique ID may be created and used. These are implementation details involving configuration and deployment parameters that will be market driven.

An embodiment of the present application can include a system including a component for registering network resource requirements, a component for allocating the network resources, and a component for generating usage indicators. The component for registering network resource requirements may be for registering network resource requirements of a plurality of application developers on a network, for registering supportable applications and supportable network resource requirements for a plurality of application service providers, for registering network resources of a plurality of network service providers for adaptive allocation based upon the registered supportable applications and supportable network resource requirements for the application service providers, and for registering a plurality of application users. The component for allocating the network resources may be for allocating the network resources to the application developers and users. Finally, the component for generating usage indicators may be for generating usage indicators for at least one of user usage and application developer usage of network resources, and generating use indicators representing use of network resources. Further, a component for generating tokens as at least one of usage and use indicators for reconciling application at least one of usage and use of network resources, may also be included.

An embodiment of the present application can encompass one or more of a network service registry method for service providers, a network resource registry method for network providers; and/or a consumer registry method for network users. A network service registry method for service providers can include registering service providers; registering network services and associated supportable applications for each service provider; generating a globally unique ID for each registered network service and provider; registering CoS requirements of each network service and supportable application; and dynamically coordinating CoS requirements for each network service and supportable application across a plurality of networks in a manor similar to that described previously with regard to other embodiments of the present application. The CoS requirements may include, but are not limited to levels of service which provide the basis for service provider usage fees; and the dynamic coordination may include, but is not limited to usage bandwidth agents, permitting allocation and exchange of bandwidth based on service agreements.

A network resource registry method for network providers can further include registering network providers; registering network resources for a network provider; generating a globally unique ID for each registered network resource and provider; registering network capabilities for each network resource; and exporting network resource information to a network management system for dynamic coordination of network resources of a plurality of network applications on the network (wherein the network resources may be those of a plurality of network providers). The network capabilities can include at least one of smart peering, MPLS labels, edge systems, support for specific protocols, and support for specific domains. The method may further include generating resource templates for registering a new network resource with capabilities similar to those of a previously registered resource. Further, the method may include generating rules for adaptive allocation of network resources based upon the exported information.

Finally, in an embodiment directed to a consumer registry method for network users, such a method may include registering consumer organizations; registering network users for each consumer organization; generating a globally unique ID for each registered consumer organization and network user; and registering service and application privileges for each network user. The method may further include generating user templates for registering a new user with privileges similar to those of a previously registered user.

It should be understood that any of the aforementioned methods of any of the aforementioned embodiments may be embodied in the form of a system for performing such a method, including various components (storage registry, CPU, servers, routers, etc.) for performing the method steps. Further, although many aspects of many embodiments have been discussed with regard to network applications, it should be understood that the embodiments also apply to network services.

Any of the aforementioned methods of any of the aforementioned embodiments may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or removable medium arranged so that it can be separated from the computer device main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1.-66. (canceled)

67. A network application registry method, comprising:
registering requirements of at least one of network applications and services;
registering network capabilities of a plurality of network providers; and
dynamically coordinating network requirements of at least one of applications and services on the network based upon the registered information, wherein the dynamic coordination includes dynamic coordination between a plurality of network providers.

68. The method of claim 67, wherein the network requirements include bandwidth allocation and latency requirements.

69. The method of claim 67, wherein the at least one of the requirements and capabilities are registered for at least one of service providers, application developers, consumers and application providers.

70. The method of claim 67, wherein the network applications include at least one of streaming audio, streaming video, voice over IP, and e-commerce.

71. The method of claim 67, further comprising, registering requirements of providers of at least one of network applications and services.

72. The method of claim 71, further comprising developing application service level maps from the registered requirements of the providers of network applications.

73. The method of claim 67, wherein the dynamic coordination includes using bandwidth agents, permitting exchange of bandwidth based on service level agreements.

74. The method of claim 67, wherein the network requirements are obtained from requirement parameters associated with a network application or service.

75. The method of claim 67, wherein the network requirements are obtained from quality of service parameters associated with a network application or service.

76. The method of claim 67, wherein the network requirements include at least one of jitter, latency requirements and bandwidth allocation requirements of a network application or service.

77. The method of claim 67, wherein the network requirements include at least one of Quality of Service (QoS) requirements and Class of Service (CoS) requirements of a network application or service.

78. The method of claim 67, wherein application developers and applications for each application developer are registered.

79. The method of claim 67, further comprising:
generating a globally unique ID for each registered application or service.

80. The method of claim 78, further comprising:
generating a globally unique ID for each registered application or service.

81. The method of claim 67, wherein the registering of requirements includes registering at least one of network and connection requirements of applications or services.

82. The method of claim 80, wherein the registering of requirements includes registering at least one of network and connection requirements of applications or services.

83. The method of claim 67, wherein the dynamic coordinating includes transferring network resource requirements for each application or service to the appropriate network resources.

84. The method of claim 82, wherein the dynamic coordinating includes transferring network resource requirements for each application or service to the appropriate network resources.

85. The method of claim 83, wherein the network resources include at least one of routers, servers and switches.

86. The method of claim 84, wherein the network resources include at least one of routers, servers and switches.

87. The method of claim 67, wherein the network requirements include at least one of Quality of Service (QoS) requirements of a network application and Class of Service requirements of a network service, and wherein the dynamic coordinating includes coordinating at least one of QoS requirements for each network application and Class of Service requirements for each network service, across the networks of the plurality of network providers.

88. The method of claim 84, wherein the network requirements include at least one of Quality of Service (QoS) requirements of a network application and Class of Service requirements of a network service, and wherein the dynamic coordinating includes coordinating at least one of QoS requirements for each network application and Class of Service requirements for each network service, across the networks of the plurality of network providers.

89. The method of claim 86, wherein the network requirements include at least one of Quality of Service (QoS) requirements of a network application and Class of Service requirements of a network service, and wherein the dynamic coordinating includes coordinating at least one of QoS requirements for each network application and Class of Service requirements for each network service, across the networks of the plurality of network providers.

90. The method of claim 67, wherein the network requirements include requirements needed to permit normal functionality of the network application or service.

91. The method of claim 67, further comprising:
generating templates for registering a new application or service with network requirements similar to that of a previously registered application or service.

92. The method of claim 86, wherein the network requirements include requirements needed to permit normal functionality of the network application or service.

93. The method of claim 86, further comprising:
generating templates for registering a new application or service with network requirements similar to that of a previously registered application or service.

94. The method of claim 92, further comprising:
generating templates for registering a new application or service with network requirements similar to that of a previously registered application or service.

95. A program, adapted to perform the method of claim 67, when executed on a computer device.

96. A computer readable medium, storing the program of claim 95.

97. A system for performing the method of claim 67.

98. The system of claim 97, further comprising a processor and a database.

99. A network application registry system, comprising:
means for registering requirements of at least one of network applications and services and for registering at least one of network applications and services in hardware of the network; and
means for dynamically coordinating network requirements of the at least one of network applications and services on the network, wherein the dynamic coordination includes dynamic coordination between at least one network application or service for each of a plurality of entities.

100. The system of claim 99, wherein the network requirements include bandwidth allocation and latency requirements.

101. The system of claim 99, wherein the plurality of entities include at least one of service providers, application developers, consumers and application providers.

102. The system of claim 99, wherein the network applications include at least one of streaming audio, streaming video, voice, and e-commerce.

103. The system of claim 99, wherein the means for registering requirements is further for registering requirements of providers of network applications or services.

104. The system of claim 103, further comprising means for developing application service level maps from the registered requirements of the providers of network applications or services.

105. The system of claim 99, wherein the dynamic coordination includes using bandwidth agents, permitting exchange of bandwidth based on service level agreements.

106. The system of claim 99, wherein the network requirements are obtained from requirement parameters associated with a network application or service.

107. The system of claim 99, wherein the network requirements are obtained from quality of service parameters associated with a network application or service.

108. The system of claim 99, wherein the network requirements include at least one of jitter, latency requirements and bandwidth allocation requirements of a network application or service.

109. The system of claim 99, wherein the network requirements include at least one of Quality of Service (QoS) requirements and Class of Service (CoS) requirements of a network application or service.

110. The system of claim 99, wherein application developers and applications for each application developer are registered.

111. The system of claim 99, further comprising:
means for generating a globally unique ID for each registered application or service.

112. The system of claim 110, further comprising:
means for generating a globally unique ID for each registered application or service.

113. The system of claim 99, wherein the registering of requirements includes registering at least one of network and connection requirements of the at least one of applications and services.

114. The system of claim 112, wherein the registering of requirements includes registering at least one of network and connection requirements of the at least one of applications and services.

115. The system of claim 99, wherein the dynamic coordinating includes transferring network resource requirements for each application or service to the appropriate network resources.

116. The system of claim 114, wherein the dynamic coordinating includes transferring network resource requirements for each application or service to the appropriate network resources.

117. The system of claim 115, wherein the network resources include at least one of routers, servers and switches.

118. The system of claim 116, wherein the network resources include at least one of routers, servers and switches.

119. The system of claim 99, wherein the network requirements include at least one of Quality of Service (QoS) requirements of a network application and Class of Service requirements of a network service, and wherein the dynamic coordinating includes coordinating at least one of QoS requirements for each network application and Class of Service requirements for each network service, across the networks of the plurality of network providers.

120. The system of claim 116, wherein the network requirements include at least one of Quality of Service (QoS) requirements of a network application and Class of Service requirements of a network service, and wherein the dynamic coordinating includes coordinating at least one of QoS requirements for each network application and Class of Service requirements for each network service, across the networks of the plurality of network providers.

121. The system of claim 118, wherein the network requirements include at least one of Quality of Service (QoS) requirements of a network application and Class of Service requirements of a network service, and wherein the dynamic coordinating includes coordinating at least one of QoS requirements for each network application and Class of Service requirements for each network service, across the networks of the plurality of network providers.

122. The system of claim 99, wherein the network requirements include requirements needed to permit normal functionality of the network application or service.

123. The system of claim 99, further comprising:
means for generating templates for registering a new application or service with network requirements similar to that of a previously registered application or service.

124. The system of claim 118, wherein the network requirements include requirements needed to permit normal functionality of the network application or service.

125. The system of claim 118, further comprising:
means for generating templates for registering a new application or service with network requirements similar to that of a previously registered application or service.

126. The system of claim 124, further comprising:
means for generating templates for registering a new application or service with network requirements similar to that of a previously registered application or service.

127.-211. (canceled)
